(19) United States
(12) Patent Application Publication
(10) Pub. No.: US 2019/0079219 A1
(43) Pub. Date: Mar. 14, 2019

(54) INHERENTLY FLAME RETARDANT COMPOUND TO DIFFUSE VISIBLE LIGHT FROM FIXTURES CONTAINING LIGHT EMITTING DIODES

(71) Applicant: PolyOne Corporation, Avon Lake, OH (US)

(72) Inventors: Jinping WU, Westlake, OH (US); Sang LEE, Westlake, OH (US)

(21) Appl. No.: 15/705,018

(22) Filed: Sep. 14, 2017

(51) Int. Cl. G02B 5/02; F21V 5/00; F21V 25/12; G02B 1/04

(52) U.S. Cl. CPC G02B 5/0242; F21V 5/002; F21Y 2115/10; G02B 5/0278; G02B 1/04; F21V 25/12

(57) ABSTRACT

Visible light actually emitted by a light emitting diode (LED) at a point source is perceived by a viewer of that LED to be sufficiently diffuse to hide the point source. A panel between the LED and the viewer is made from a mixture of polyvinyl halide polymer in a continuous phase and visible light refracting polymeric particles in a discontinuous phase. The polyvinyl halide has a refractive index different from the particles, and both have a different refractive index from air. Optical refraction causes the diffusion, providing “hiding power” to the panel, which is beneficially, inherently flame retardant because of the use of the polyvinyl halide as the continuous phase.

### FIELD OF THE INVENTION

This invention relates to a method to cause diffusion of visible light emanating from light emitting diodes via refraction without appreciable loss of light transmission, by use of a thermoplastic panel intermediate between the light emitting diodes and a viewer of light from such light emitting diodes.

### BACKGROUND OF THE INVENTION

Light emitting diodes (“LEDs”) are rapidly becoming popular for interior and exterior lighting because of their lower energy consumption as compared with incandescent lamps.

LEDs are produced in commercial quantities at a variety of color temperatures. A typical display of LEDs on sale in a commercial retail store includes LEDs in the range of “Soft White” (2700 K); “Warm White” (3000 K); “Bright White” (3500 K); and “Daylight” (5000 K), where the color temperature from 2700-5000 is measured in degrees Kelvin.

LEDs are point sources of light, intense in origin of their luminosity. Therefore, as with conventional lighting fixtures with incandescent light, the LEDs are visible as point sources of light unless the fixture is modified to provide a translucent or transmissive panel with “hiding power” to diffuse the transmitted light enough to hide the particular location(s) of the LEDs within the lighting fixture.

Lighting fixtures and many other articles for interior spaces where human occupation is possible need materials which are flame retardant sufficiently to meet or exceed regulatory and industrially managed standards.

### SUMMARY OF THE INVENTION

What the art needs is a material which can be inexpensively made and used in a thermoplastic panel intermediate between the light emitting diodes and a viewer of light from such light emitting diodes to diffuse the point source(s) of LED generated light (“hiding power”) without appreciable loss of transmitted light.

It has been found that a mixture of a particular polymer and a particular type of particle can provide diffusion and hiding power via refraction of visible light without appreciable loss of light transmission through the mixture.

One aspect of this disclosure is a mixture of a continuous phase of polyvinyl halide and a discontinuous phase of visible light refracting particles having a different refractive index from the polyvinyl halide, wherein the mixture is sufficiently inherently flame retardant as to pass UL 94 V-0 at 0.75 mm and 5 VA at 2.0 mm without the presence of flame retardant additives.

Another aspect of this disclosure is a light transmissive panel having hiding power for LED visible lights made from the mixture identified above.

Another aspect of this disclosure is a LED lighting fixture having a panel identified above.

### EMBODIMENTS OF THE INVENTION

Polyvinyl Halides

Any polyvinyl halide capable of translucency in the shape of panel is a candidate for use in this invention, because of their inherent transparency and suitability for compounding with other materials for affecting the degree of light transmission and translucency, as well as their inherent flame retardant properties arising from the presence of halide moieties which naturally retard onset and continuity of combustion in the presence of oxygen. Polyvinyl chloride polymers are presently preferred.

Polyvinyl chloride polymers are widely available throughout the world. Polyvinyl chloride resin (PVC), as referred to herein, includes polyvinyl chloride homopolymers, vinyl chloride copolymers, graft copolymers, and vinyl chloride polymers polymerized in the presence of any other polymer such as a heat distortion temperature enhancing polymer, impact toughener, barrier polymer, chain transfer agent, stabilizer, plasticizer or flow modifier.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene chloride, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The present invention can also use chlorinated polyvinyl chloride (CPVC), wherein PVC containing approximately 57% chlorine is further reacted with chlorine radicals produced from chlorine gas dispersed in water and irradiated to generate chlorine radicals dissolved in water to produce CPVC, a polymer with a higher glass transition temperature (Tg) and heat distortion temperature. Commercial CPVC typically contains by weight from about 58% to about 70% and preferably from about 63% to about 68% chlorine. CPVC copolymers can be obtained by chlorinating such PVC copolymers using conventional methods such as that described in U.S. Pat. No. 2,996,489, which is incorporated herein by reference. Commercial sources of CPVC include Lubrizol Corporation.

The preferred composition is a polyvinyl chloride homopolymer, which has a refractive index ranging from about 1.52 to about 1.55 and preferably from about 1.53 to about 1.54.

Commercially available sources of polyvinyl chloride polymers include OxyVinyls LP of Dallas, Tex. and Shintech USA of Freeport, Tex.

Compounds of Resins

Thermoplastic resin compounds typically contain a variety of additives selected according to the performance requirements of the article produced therefrom well within the understanding of one having ordinary skill in the art without the necessity of undue experimentation.

But it is significant for this disclosure that the PVC mixture not contain any additives which could appreciably decrease the light transmission properties of the PVC. Hiding power disguises the location of the point sources of LED when the PVC mixture is made into a panel for positioning between the LED lights and the viewer of such visible light.

Of all possible thermoplastic compounds, polyvinyl chloride polymer homopolymers whose inherent viscosity ranges from 0.4 to 1.3, preferably 0.5 to 0.8 are presently preferred for use in making mixtures of this invention.

Visible Light Refracting Particles

It has been found that polymethyl methacrylate (PMMA) or polymethylsilsesquioxane (PMSQ) or polystyrene (PS) have refractive indices different enough from PVC that particles of them, usually spheres or spheroids, can refract point sources of light to cause diffusion of such light.

The particles can range in mean particle size from about 2 μm to about 60 μm and preferably from about 2 μm to about 6 μm.

The particles can range in average particle size from about 2 μm to about 60 μm and preferably from about 2 μm to about 6 μm.

The particles can be present in the polyvinyl halide can range in parts per hundred resin (PHR) from about 0.1 to about 10 and preferably from about 0.2 to about 2.5.

The PMMA particles can have a refractive index ranging from about 1.490 to about 1.497 and preferably from about 1.494 to about 1.496.

The PMSQ particles can have a refractive index ranging from about 1.420 to about 1.425 and preferably from about 1.420 to about 1.422.

The PS particles can have a refractive index ranging from about 1.590 to about 1.597 and preferably from about 1.593 to about 1.595.

With particles of either PMMA or PMSQ or PS or both dispersed within a PVC homopolymer, the PVC becomes a continuous polymer phase while the particles become a dispersed or discontinuous polymeric phase.

Applying the laws of optics, in its most basic occurrence, visible light from a point source such as a LED reaches a light transmissive panel made from visible light refracting particles in PVC whereupon such light is refracted to the extent of the difference between the refractive index of air and the refractive index of the PVC.

Such initially refracted light proceeds through the PVC until it encounters the spherical or spheroidal surface of one of the visible light refracting particles dispersed in the PVC, whereupon such light is refracted to the extent of the difference between the refractive index of PVC and the refractive index of the PMMA, PMSQ, or PS.

Such doubly refracted light then proceeds through the particle until it leaves the spherical or spheroidal surface and enters the PVC again, whereupon such light is refracted to the extent of the difference between the refractive index of PMMA, PMSQ, or PS and the refractive index of the PVC.

Such triply refracted light proceeds through the PVC until it leaves the panel and enters the air again, whereupon such light is refracted to the extent of the difference between the refractive index of PVC and the refractive index of the air. That triply refracted light emerges from the light transmissive panel in a different location than the point of source of LED visible light.

It is possible and likely that doubly refracted light identified above encounters another spherical or spheroidal particle in the PVC before completely transiting the thickness of the panel. Thus, the complexity of the predictable refractions of visible light further diffuse the incident original LED light quadruply, quintuply, or more times.

Multiplied by the number of particles in the PVC continuous phase, as well as the PVC itself, the array of point sources of LED light diffuse without appreciable loss of transmission, causing the desired hiding power for the LED lighting fixture.

It has been found that a panel of PVC and light refracting particles therein, the panel having a thickness ranging from about 1.5 mm to about 3.0 mm and preferably from about 1.5 mm to about 2.0 mm, can have a light transmission ranging from about 70% to about 85% and preferably from about 75% to about 83%. By comparison a panel of PVC of the same thickness had a light transmission of from about 75% to about 85% and preferably from about 80% to about 85%. Thus, light transmission without appreciable loss can range from about 1% to about 6% and preferably from about 1% to about 5%.

Any other additive which causes appreciable loss of light transmission from the light transmission percentage of the panel without such additive above is discouraged for use in the mixture of PVC and visible light refracting particles.

Stated another way, if 85% is the theoretically possible light transmission percentage for the inherently flame retardant polyvinyl halide in the panel, then 80% is the practically possible light transmission percentage for the polyvinyl halide panel with the visible light refracting particles, and any lower percentage caused by any other additive is discouraged or even refused.

The manufacturer of the PMMA particles sells such particles for light refraction diffusion for use in a variety of polymers. But the problem in the art is that the polymeric continuous phase of LED light diffusing panels have not been the inherently flame retardant polyvinyl halide candidates identified above. For that reason, to comply with regulatory and industrially established standards, such LED light diffusing panels have also required the presence of flame retardants which cause an unacceptable decrease in visible light transmission through the panel.

Use of polyvinyl halide, and particularly PVC homopolymer, can provide both the light transmission properties and the flame retardance for use in a LED lighting panel. Though both polyvinyl halide and PMMA particles have been known, they have not been combined to achieve the multiple advantages identified in this disclosure.

Optional Additives

The compound of the present invention can include conventional plastics additives in an amount that is sufficient to obtain a desired processing or performance property for the compound, so long as there is resulting no light transmission percentage in the panel lower than the light transmission percentage of the polyvinyl halide and the visible light refracting particles.

The amount of any optional additive should not be wasteful of the additive or detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

If there is no appreciable loss of light transmission, using PVC as only one possible embodiment, PVC compounds suitable for use in this disclosure can contain effective amounts of additives ranging from none at all, namely 0.00, to about 500 weight parts per 100 weight parts of PVC (parts per hundred resin or “phr”).

For example, various primary and/or secondary lubricants such as oxidized polyethylene, paraffin wax, fatty acids, and fatty esters and the like can be utilized.

Thermal and ultra-violet light (UV) stabilizers can be utilized such as various organo tins, for example dibutyl tin, dibutyltin-S-S′-bi-(isooctylmercaptoacetate), dibutyl tin dilaurate, dimethyl tin diisooctylthioglycolate, mixed metal stabilizers like Barium Zinc and Calcium Zinc, and lead stabilizers (tri-basic lead sulfate, di-basic lead phthalate, for example). Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soybean oil can be used. Typical levels of secondary stabilizers range from about 0.1 wt. parts to about 10.0 wt. parts per 100 wt. parts PVC (phr).

In addition, antioxidants such as phenolics, BPA, BHT, BHA, various hindered phenols and various inhibitors like substituted benzophenones can be utilized.

Various processing aids, fillers, flame retardants and reinforcing materials can also be utilized in amounts up to about 20 or 30 phr. Exemplary processing aids are acrylic polymers such as poly methyl (meth)acrylate based materials.

Adjustment of melt viscosity can be achieved as well as increasing melt strength by employing 0.5 to 5 phr of commercial acrylic process aids such as those from Dow Chemical under the Paraloid® trademark. Paraloid®. K-120ND, K-120N, K-175, and other processing aids are disclosed in The Plastics and Rubber Institute: International Conference on PVC Processing, Apr. 26-28 (1983), Paper No. 17.

Examples of fillers include calcium carbonate, clay, silica and various silicates, talc, carbon black and the like. Reinforcing materials include glass fibers, polymer fibers and cellulose fibers. Such fillers are generally added in amounts of from about 0 to about 500 phr of PVC. Preferably from 0 to 300 phr of filler can be employed.

Also, flame retardant fillers like ATH (Aluminum trihydrates), AOM (ammonium octamolybdate), antimony trioxides, magnesium oxides and zinc borates are added to boost the flame retardancy of polyvinyl chloride which is already inherently flame retardant.

The concentrations of these fillers could range from 0 phr to 200 phr. In other words, it is possible, indeed desirable, for the PVC to have no additives which decrease the light transmission properties of the PVC and the visible light refracting particles.

Processing

The preparation of compounds of the present invention is uncomplicated. The compound of the present invention can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

Panel of Thermoplastic Compounds

Regardless of the selection of ingredients identified above, the panels of the present invention need to be appreciably light transmissive to permit efficient passage of light emitted from the LED through the entire thickness of the panel to be perceived by a viewer on a side of the panel distant from the LED. For example, a ceiling lighting fixture could have one or more LEDs within the frame of the fixture with one side of the fixture facing the floor being a panel of the present invention. That panel needs to be translucent for the passage of light but also needs to be sufficiently flame retardant to satisfy fire protection standards and to be sufficiently diffuse in order hide the point source location of the LEDs.

The panel can be any size to accommodate any number of LEDS, whether the panel is vertical as a lighted wall sign or horizontal as a ceiling fixture. The length of a preferred panel can range from about 0.254 cm (0.1 inch) to about 3.04 m (10 feet) and preferably from about 2.54 (1 inch) to about 121 cm (4 feet). The width of a preferred panel can range from about 12.7 cm (5 inches) to about 3.04 m (10 feet) and preferably from about 2.54 (1 inch) to about 182 cm (6 feet).

The thickness of a panel can affect its translucency. Again, one having ordinary skill in the art without undue experimentation can determine the appropriate thickness of the panel through which the LED light travels. For example, the thickness of a panel can range from about 0.5 mm to about 10 mm and preferably from about 1.5 mm to about 5 mm For panels of such thicknesses, translucency or light transmission percent can range from about 30% to about 90% and preferably from about 50% to about 85% as measured using ASTM D1003.

Panels can be made using any conventional polymer shaping technique, including without limitation, extrusion, molding, calendering, thermoforming, casting, etc.

### USEFULNESS OF THE INVENTION

Panels can be placed between any LED and a viewer of that LED and be diffusive enough to hide the point source of the LED. End uses for such panels include, without limitation, lighting fixtures of all types, backlit signage of all types, general illumination, display lighting, automotive, and mobile devices.

These panels improve the appearance of luminosity uniformity for LED light point sources such that the point sources may not be identifiable when viewing the light through the lighting fixture.

### EXAMPLE

100 phr polyvinyl chloride polymer made by Shintech was melt-mixed with 1 phr of PMMA particles made by Sekisui having a mean particle size of 5 μm, an average particle size of 5 μm, and a refractive index of 1.495, well dispersed in the PVC.

A panel of that mixture was made for testing using a Haze Gard plus from BYK following ASTM D1003.

When fully lit, the panel was viewed at approximately a 25.4 cm (10 inch) distance. Because of the complexity of optical refractions of the visible light from the LEDs, caused at the several interfaces of air and PVC and PVC and PMMA, the viewer could not identify the point sources of the LED-generated light. This panel was found to have “hiding power” without appreciable loss of light transmission in a mixture which was inherently flame retardant.

The polymeric mixture in a plaque having a 0.75 mm thickness passed V-0 and 2.0 mm thickness passed 5 VA flame test measured using UL 94 test procedure without the presence of any flame retardant additive such as brominated flame retardants, non-halogenated flame retardants, or the like.

The invention is not limited to the above embodiments. The claims follow.

What is claimed is:

1. A mixture of polymers, comprising:
(a) a continuous phase of polyvinyl halide and
(b) a discontinuous phase of visible light refracting particles having a different refractive index from the polyvinyl halide, wherein the mixture is sufficiently inherently flame retardant as to pass UL V-0 at 0.75 mm and 5 VA at 2.0 mm without the presence of flame retardant additives.

2. The mixture of claim 1, wherein the particles comprise polymethyl methacrylate (PMMA) or polymethylsilsesquioxane (PMSQ) or polystyrene (PS) or combinations of them.

3. The mixture of claim 1, wherein the particles have an average particle size from about 2 μm to about 60 μm and preferably from about 2 μm to about 6 μm.

4. The mixture of claim 1, wherein the particles are present in the polyvinyl halide in parts per hundred resin (PHR) from about 0.1 to about 10.

5. The mixture of claim 4 wherein the particles are present in the polyvinyl halide in PHR from about 0.2 to about 2.5.

6. The mixture of claim 2, wherein the PMMA particles have a refractive index ranging from about 1.490 to about 1.497.

7. The mixture of claim 2, wherein the PMSQ particles have a refractive index ranging from about 1.420 to about 1.425.

8. The mixture of claim 2, wherein the PS particles can have a refractive index ranging from about 1.590 to about 1.597.

9. The mixture of claim 1, wherein the polyvinyl halide is polyvinyl chloride.

10. The mixture of claim 9, wherein the polyvinyl chloride is polyvinyl chloride homopolymer having a refractive index ranging from about 1.52 to about 1.55.

11. A light transmissive panel for visible light spectrum LED light, comprising the mixture of claim 1, wherein light from the LED is sufficiently diffused to hide the point source location of the LED.

12. The panel of claim 11, wherein the panel has a thickness of from about 0.5 mm to about 10 mm

13. The panel of claim 12, wherein when the panel has a thickness ranging from about 1.5 mm to about 3 0 mm, the loss of light transmission can range from about 1% to about 6% as compared with a panel of the same thickness having the same polyvinyl halide but no visible light refracting particles.

14. The panel of claim 12, wherein the panel, having a thickness ranging from about 1.5 mm to about 3 0 mm, has a light transmission ranging from about 70% to about 85%.

15. A LED lighting fixture, comprising (a) at least one LED and (b) a panel of claim 11.
